(19) United States
(12) Patent Application Publication
(10) Pub. No.: US 2012/0027581 A1
(43) Pub. Date: Feb. 2, 2012

(54) REINFORCED CONCRETE GAS TURBINE OUTER CASE

(75) Inventors: Dwight DAVIDSON, Greer, SC (US); Herbert ROBERTS, Simpsonville, SC (US)

(73) Assignee: GENERAL ELECTRIC COMPANY, Schenectady, NY (US)

(21) Appl. No.: 12/848,659

(22) Filed: Aug. 2, 2010

(51) Int. Cl. F04D 29/40; B29C 39/10

(52) U.S. Cl. 415/214.1; 264/279

(57) ABSTRACT

A turbomachine outer case includes a pair of outer case sections, each provided with attachment flanges for securing said pair of outer case sections about an internal rotor structure, the pair of outer case sections constructed of a cement composite material. The outer case sections may be lined with a relatively thin metal alloy.

### BACKGROUND OF THE INVENTION

This invention relates to ground-based turbomachines in general to an external structural case that supports the axial and torsional loads transferred across a turbine during engine operation.

Conventional turbine outer cases are formed from large metal-based sand castings that mount inner case structures for supporting, in the case of a gas turbine, the components of the hot gas path. Metal outer cases have thermal structural issues, however, that impact rotor alignment and blade tip clearances within the hot gas path. There have been some attempts to remedy the issues associated with metal outer cases by using multiple cases to isolate the thermal and axial structural loading.

It would be desirable to develop a less complex case structure for removing or isolating thermal properties from the outer case of a turbomachine such as a gas turbine, for example, and thereby reduce the impact of the outer case on the internal hot gas path components.

### BRIEF SUMMARY OF THE INVENTION

In accordance with an exemplary but non-limiting embodiment, the present invention provides a turbomachine outer case comprising a pair of outer case sections, each provided with attachment flanges for securing the pair of outer case sections about an internal rotor structure, the pair of outer case sections constructed of a cement composite material.

In another aspect the invention provides a turbomachine outer case comprising a pair of substantially semi-cylindrical outer case sections, each provided with attachment flanges along opposite free ends thereof for securing the pair of substantially semi-cylindrical outer case sections about an internal rotor structure, the pair of substantially semi-cylindrical outer case sections constructed of a relatively thick cement composite material lined with a relatively thin metal material.

In still another aspect, the present invention provides a method of forming an outer case section for a turbine comprising preparing a split mold with reinforcing bars and attachment hardware elements incorporated therein; pouring uncured concrete into said split mold to form a pair of reinforced concrete case sections with attachment flanges adapted to facilitate attachment of said pair of case sections together about an internal rotor structure; curing the concrete; and removing the split mold.

The invention will now be described in connection with the drawings identified below.

### BRIEF DESCRIPTION OF THE DRAWINGS

FIG. 1 is a partial schematic illustration of a turbine with a monolithic metal outer case and its relationship to the interior rotor system;

FIG. 2 is a schematic end view or cross-section of a turbine split metal case of the type shown in FIG. 1;

FIG. 3 is schematic illustration similar to FIG. 1 but showing a composite concrete outer case wall with reinforcement bars and local airfoil connectivity points in accordance with a first exemplary but non-limiting embodiment of the invention;

FIG. 4 is a schematic and/or end or cross-section similar to FIG. 2 but illustrating the turbine split composite case as shown in FIG. 3; and

FIG. 5 is a flow diagram of a process according to an exemplary embodiment of the invention.

### DETAILED DESCRIPTION OF THE INVENTION

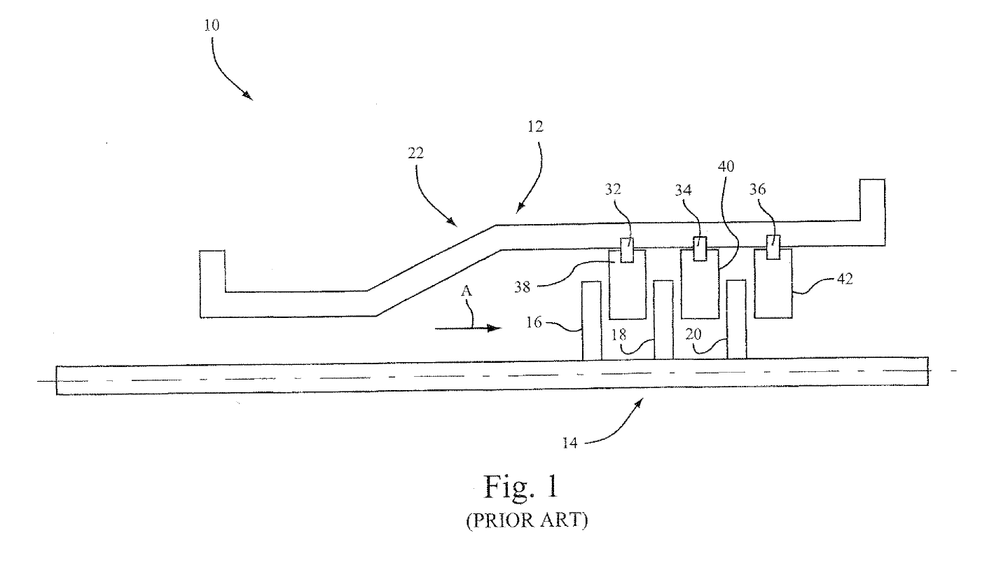

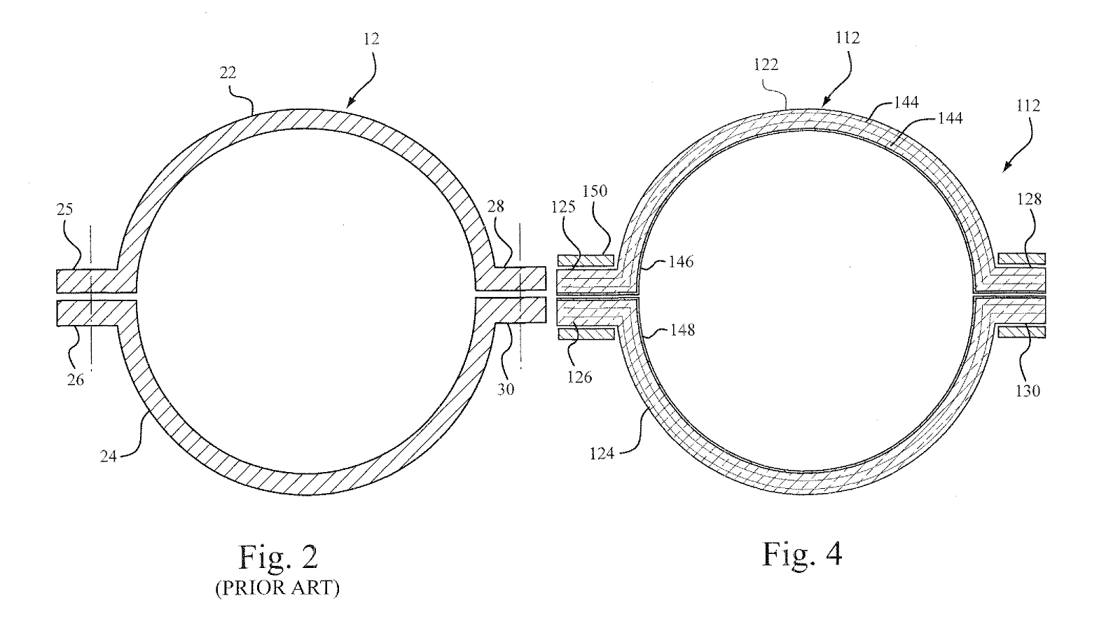

With reference initially to FIGS. 1 and 2, a ground-based turbine section 10 includes an outer case 12 that encloses an internal rotor system 14. In the exemplary embodiment, the turbomachine is a gas turbine but the invention is not limited to gas turbines. The internal rotor system includes a plurality of stages, each of which, as understood by those skilled in the art, includes a turbine wheel mounting an annular row of blades or buckets. Three stages are represented schematically at 16, 18 and 20 in FIG. 1.

The annular outer case or housing 12 is comprised of an upper substantially semi-cylindrical case half 22 and a lower substantially semi-cylindrical case half 24, best seen in FIG. 2. The upper and lower case halves are secured at aligned, horizontal flange pairs 24, 26 and 28, that extend length-wise along the outer case 12, by means of suitable bolts or other equivalent fasteners (not shown) extending through axially-spaced holes in the respective flange pairs.

The interior of the outer case 12 is provided with attachment points or hardware elements 32, 34 and 36 which support respective stationary stator or nozzle diaphragms 32, 40 and 42 which extend radially between the respective stages 16, 18 and 20. Combustion gases exiting the turbine combustion chamber(s) flow along the rotor 14 through the plural stages 16, 18, 20 as indicated by flow arrow A in a path generally referred to as the “hot gas path”.

As indicated above, the outer case or housing 12 is typically made of cast metal such as a steel alloy, giving rise to thermal gradient issues affecting rotor alignment and blade tip clearances.

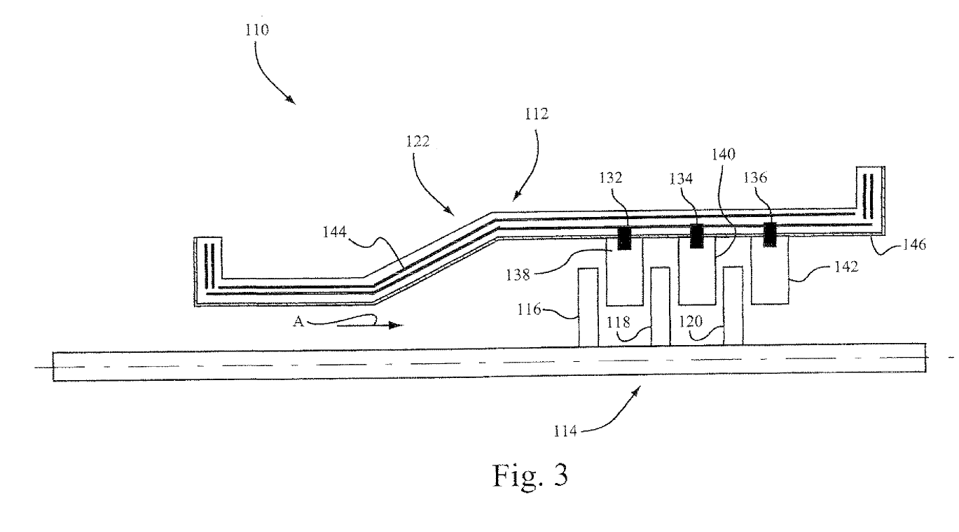

Turning now to FIGS. 3 and 4, a ground-based turbine 110 in accordance with an exemplary but non-limiting embodiment of the present invention is schematically illustrated in a manner similar to the outer case shown in FIGS. 1 and 2. The turbine 110 includes an outer case 112 that encloses an internal rotor system 114. The internal rotor system 114 also includes a plurality of stages represented at 116, 118 and 120, each of which includes a turbine wheel mounting an annular row of blades or buckets.

As in the prior known case construction, the outer case or annular housing 112 is comprised of an upper, substantially semi-cylindrical case half or section 122 and a lower substantially semi-cylindrical case half or section 124 (FIG. 4) secured at horizontal flange pairs 124, 126 and 128, 130 that extend axially along the length of the outer case 112, by means of suitable bolts or other equivalent fasteners extending through the respective flange pairs.

The interior of the outer case 112 is provided with attachment points or hardware elements 132, 134 and 136 which support respective stationary stator or nozzle diaphragms 138, 140 and 142 which extend radially between the respective stages 116, 118 and 120 along the hot gas path.

In the exemplary but nonlimiting embodiment, the outer case 112 is comprised of a ceramic cement composite, e.g., concrete, with an internal grid of metal or composite reinforcement bars 144. The placement or arrangement of the reinforcing bars (or “rebars”) 144 will be in accordance with usual reinforced concrete practice generally within the skill of the art. In addition, the exact chemical composition of the concrete may vary with individual applications, considering the particular thermal gradients of the system.

The local metal nozzle connectivity points or hardware elements 132, 134 and 136 may be embedded within the concrete structure and may be of conventional design with respect to the manner in which the stator or nozzle diaphragms 138, 140 and 142 are secured to those hardware elements.

In a preferred construction, a thin metal liner, in the form of split liner halves 146, 148, is provided on the interior side of the upper and lower case halves 122, 124. The split metal liner substantially conforms to the interior surfaces of the upper and lower case halves and acts as a pressure vessel which prevents combustion gas leakage from the case in the event that hairline (or larger) cracks form in the concrete outer case. The metal liner, preferably a chromium steel alloy, would also serve to enhance the connectivity points for the stator components. Other suitable liner materials include glass-based composites and high-temperature plastics or other high temperature metals.

In the example embodiment, the inner metal liner may be from about ¼ to 1 inch thick, while the concrete outer case may be from about 6 to 8 inches thick, but it will be understood that these dimensions may vary.

In accordance with the exemplary embodiment, the reinforced concrete case is produced in an as-cast state, about the inner metal liner, and only the local connectivity points 132, 134 and 136 require follow-up machining. The reinforced concrete structure is resistant to thermal stress during gas turbine operation, and will carry the axial and torsional loading of the gas turbine during operation.

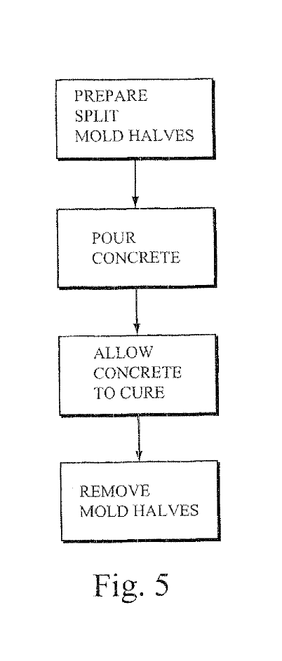

Manufacture of the outer case is somewhat similar to a concrete reinforced pipe section in that the reinforcement bars, metal mounting elements as shown in FIGS. 3 and 4 can be located and fixed within a split mold. The liquid-based cement is then poured and cured, after which the split mold halves are removed (see FIG. 5).

The split mold with split liner halves enable the concrete reinforced case itself to be constructed in a split configuration so that the case can be fitted around an existing gas turbine rotor assembly and joined at the split flange arrangement described above. Metal flange components 150 may be secured to the mold prior to concrete pouring and curing so that the flange components 150 are at least partially embedded in the concrete, extending along exterior surfaces of the flange pairs 124, 126 and 128, 130 and providing more robust attachment points for the bolts or other fasteners used to secure the case halves.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A turbomachine outer case comprising:
a pair of outer case sections, each provided with attachment flanges for securing said pair of outer case sections about an internal rotor structure, said pair of outer case sections constructed of a cement composite material.

2. The turbomachine outer case of claim 1 wherein said pair of outer case sections are constructed of reinforced concrete material.

3. The turbomachine outer case of claim 1 wherein each outer case section is provided with multiple connectivity elements for securing internal stator components thereto.

4. The turbomachine outer case of claim 1 wherein said pair of outer case sections are each substantially semi-cylindrical in shape.

5. The turbomachine outer case of claim 1 wherein said outer pair of case sections are each between 6-8 inches thick.

6. The turbomachine outer case of claim 1 wherein each outer case section is provided with an internal metal liner substantially conforming to internal surfaces of said case section.

7. The turbomachine outer case of claim 6 wherein said metal liner comprises a chromium steel alloy with a thickness of between about % and 1 inch.

8. The turbomachine outer case of claim 4 wherein said attachment flanges comprise horizontally-oriented flanges extending along and away from opposite free ends of said substantially cylindrical case sections, thus providing an aligned pair of attachment flanges on opposite sides of said substantially cylindrical case sections.

9. The turbomachine outer case of claim 8 wherein each of said attachment flanges is substantially covered on its respective exterior surface with a metal plate.

10. A turbomachine outer case comprising:
a pair of substantially semi-cylindrical outer case sections, each provided with attachment flanges along opposite free ends thereof for securing said pair of substantially semi-cylindrical outer case sections about an internal rotor structure, said pair of substantially se cylindrical outer case sections constructed of a relatively thick cement composite material lined with a relatively thin metal material.

11. The turbomachine outer case of claim 10 wherein said pair of substantially semi-cylindrical outer case sections are constructed of reinforced concrete.

12. The turbomachine outer case of claim 1 wherein each of said pair of substantially semi-cylindrical outer case sections is provided with multiple connectivity elements for securing internal stator components thereto.

13. The turbomachine outer case of claim 10 wherein said outer pair of case sections are each between about 6 and 8 inches thick.

14. The turbomachine outer case of claim 13 wherein said metal liner comprises a chromium steel alloy with a thickness of between about ¼ and 1 inch.

15. The turbomachine outer case of claim 10 wherein each of said attachment flanges is substantially covered on its respective exterior surface with a metal plate.

16. A method of forming an outer case section for a turbomachine comprising:
(a) preparing a split mold with reinforcing bars and attachment hardware elements incorporated therein;
(b) pouring uncured concrete into said split mold to form a pair of reinforced concrete case sections with attachment flanges adapted to facilitate attachment of said pair of case sections together about an internal rotor structure;
(c) curing the concrete; and
(d) removing the split mold.

17. The method of claim 18 wherein step a) includes incorporation of a metal liner about which the uncured concrete is poured.

18. The method of claim 16 wherein said pair of outer case sections are each substantially semi-cylindrical in shape.

19. The method of claim 16 wherein said outer pair of case sections are each between about 6 and 8 inches thick.

20. The method of claim 17 wherein said metal liner comprises a chromium steel alloy with a thickness of between about ¼ and 1 inch thick.
